(19) United States
(12) Patent Application Publication
(10) Pub. No.: US 2017/0305121 A1
(43) Pub. Date: Oct. 26, 2017

(54) High-Performance Coated Sealants

(71) Applicant: Jindal Films Americas LLC, LaGrange, GA (US)

(72) Inventors: Thierry J.L. Dabadie, Luxembourg (LU); Laurent Chantraine, Strassen (LU); Anand Sundararaman, Pittsford, NY (US); Eric T. Gohr, Midwest City, OK (US); Michael A. Hubbard, Stillwater, OK (US); Lindsay J. Mendes, Naperville, IL (US)

(73) Assignee: Jindal Films Americas LLC, LaGrange, GA (US)

(21) Appl. No.: 15/518,202

(22) PCT Filed: Oct. 9, 2015
(86) PCT No.: PCT/US15/55016

§ 371 Date: Apr. 10, 2017

Related U.S. Application Data
(60) Provisional application No. 62/061,746, filed on Oct. 9, 2014.

(51) Int. Cl. B32B 25/08; B32B 25/14; B32B 27/08; B32B 27/16; B32B 27/34; B32B 27/32; B32B 27/30; B32B 27/20; B32B 27/36; B29C 47/30; B29C 47/00; B29B 9/06

(52) U.S. Cl. CPC B32B 25/08; B32B 27/20; B32B 25/14; B32B 27/08; B32B 27/16; B32B 27/36; B32B 27/34; B32B 27/32; B32B 27/306; B29C 47/0014; B29B 9/06; B29C 47/30; B32B 2553/00

(57) ABSTRACT

Disclosed is a multilayered film that includes a core layer that includes one or more polymers, wherein the core has a first side and a second side and is optionally oriented. Further, the multilayered film includes a sealing layer comprising a primer and a sealing coating, wherein the primer has a primer coating weight from 0.05 to 0.5 g/m² and is located between the first side of the core and a first side of the sealing coating, wherein the sealing coating has a sealing coating weight from 0.5 to 20.0 g/m², wherein the multilayered film has a seal strength of at least 1 kg/in at 120° C. In various embodiments, the films showed outstanding seal strength, hot tack for both clear and white films over a broad temperature range, seal integrity under the Skye test, low blocking, and other desirable performance metrics.

### REFERENCE TO RELATED APPLICATION

The present application claims priority to patent cooperation treaty (PCT) application having PCT Application Number PCT/US2015/055016, entitled “High Performance Coated Sealants,” filed 9 Oct. 2015, which claims priority to U.S. Provisional Application Ser. No. 62/061,746 filed 9 Oct. 2014. Both of the above-listed priority applications are hereby incorporated by reference in their entirety.

### FIELD

The disclosure relates to high-performance coated sealants in multilayered films, processes applied thereto, products made therefrom such as bags, tags, packages, labels, and other structures, and uses thereof, such as to contain foods, beverages, and other articles or other finished products uses, such as those stated hereinbelow.

### BACKGROUND

This disclosure relates to an improved, lamination grade, coextruded, films and other structures that exhibit one or a host of desirable performance metrics, including, for example outstanding seal strength, hot tack for both clear and white films over a broad temperature range, seal integrity under the Skye test, low blocking, low coefficient of friction, and others.

“Seal Strength” is a quantitative measurement used, for example, in process validation, process control, and capability. Seal strength is not only relevant to opening force and package integrity, but to measuring the packaging processes' ability to produce consistent seals. Seal strength at some minimum level is a necessary package requirement, and at times it is desirable to limit the strength of the seal to facilitate opening.

“Hot tack” is the strength of a heat seal immediately after sealing while still in a hot condition, i.e., before it has cooled down to ambient temperature and achieved its final strength.

“Seal integrity,” tests the completeness or “integrity” of the seal, such as in a sealed package. Under the Skye test, use of a Skye tester consists of a needle to be inserted in to a pouch and in a pressure measurement device. The pouch is inflated with air through the needled and the rupture pressure is measured. This is a measure of the rupture strength of the pouch at that sealing condition. For instance, by repeating the test for different sealing combinations, rupture strength can be plotted against sealing time at constant sealing temperature.

“Blocking” is a tendency for an adhesive effect to develop between layers of film, particularly when the layers are under pressure, for instance, in a stored reel.

“Coefficient of friction” is the ratio of the force of friction between an object and a surface to the frictional force resisting the motion of the object.

Methods of forming and use of multilayered films and other structures based thereon, as well as products and applications, that have high-performance coated sealants are useful in various industries.

### SUMMARY

In one embodiment, disclosed is a multilayered film that includes a core layer comprising one or more polymers, wherein the core has a first side and a second side and is optionally oriented. Further, the multilayered film includes a sealing layer comprising a primer and a sealing coating, wherein the primer has a primer coating weight from 0.05 to 0.5 g/m² and is located between the first side of the core and a first side of the sealing coating, wherein the sealing coating has a sealing coating weight from 0.5 to 20.0 g/m², wherein the multilayered film has a seal strength of at least 1 kg/in at 120° C.

In another embodiment, disclosed is a method of forming a multilayered film that includes a core layer comprising one or more polymers, wherein the core has a first side and a second side and is optionally oriented. Further, the method includes a sealing layer comprising a primer and a sealing coating, wherein the primer has a primer coating weight from 0.05 to 0.5 g/m² and is located between the first side of the core and a first side of the sealing coating, wherein the sealing coating has a sealing coating weight from 0.5 to 20.0 g/m², wherein the multilayered film has a seal strength of at least 1 kg/in at 120° C.

In yet another embodiment, disclosed is use of a multilayered film in a packaging, tagging, bagging, or labeling application, wherein the multilayered film includes a core layer comprising one or more polymers, wherein the core has a first side and a second side and is optionally oriented. Further, the multilayered film includes a sealing layer comprising a primer and a sealing coating, wherein the primer has a primer coating weight from 0.05 to 0.5 g/m² and is located between the first side of the core and a first side of the sealing coating, wherein the sealing coating has a sealing coating weight from 0.5 to 20.0 g/m², wherein the multilayered film has a seal strength of at least 1 kg/in at 120° C.

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 depicts a tabular representation of example embodiments of the disclosed methods, systems and apparatuses of the at least three layers of the multilayer film.

FIG. 2 depicts a tabular representation of example embodiments of the disclosed methods, systems and apparatuses for the sealing layer of the at least three layers of the multilayer film.

FIGS. 3-15 show experimental results obtained in relation to the disclosed methods, apparatuses and compositions of films herein.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

This disclosure relates to methods, compositions, and apparatuses that include a multilayer film having at least three layers that exude outstanding sealability (e.g., heat-seal performance, such as in terms of strength and integrity), printability, flexibility, packaging, and machinability characteristics. These characteristics may result in preferential replacement of laminates existing in some comparable methods, compositions, and apparatuses. Applications for the disclosed methods, compositions, and apparatuses may include, for example, Horizontal-Form-Fill-and-Seal (“HFFS”), Vertical-Form-Fill-and-Seal (“VFFS”), lids, sachets, stand-up pouches, overwrap, pre-made bags, and so forth.

One of these at least three layers is the core or base layer, i.e., “core layer,” which may include one or more polymers, such as and without limitation, polypropylene-based polymers (“PP”) or co-polymers thereof, polyester-based polymers (“PET”) (e.g., polyethylene-naphthalate-based polymers (“PEN”), polylactide-based polymers (“PLA”), etc.), polyethylene-based polymers (“PE”) or co-polymers thereof, polyamide-based polymers (“PA”) and combinations thereof. These one or more polymers comprising the core layer may be coextruded. Additionally and alternatively, the core layer may be oriented monoaxially in the machine or transverse direction; in the alternative, the core layer may be oriented biaxially (“BO”). The orienting, itself, may occur one or multiple times in the machine or transverse directions, or, in both the machine and transverse directions. The core layer may further include elastomers, plastomers, ethylene-vinyl-alcohol (“EVOH”) -based polymers and combinations thereof. The core layer may further still include additives such as surfactants, waxes, anti-blocking/slip agents, cavitating or void-initiating agents, opacifying agents, pigments, colorants, antioxidants, anti-fog agents, anti-static agents, fillers, moisture barrier additives, gas barrier additives, wetting agents, adhesion agents, and combinations thereof.

In one example embodiment, the core layer includes a biaxially oriented polypropylene (“BOPP”), such as an ethylene-propylene (“EP”) copolymer, an ethylene-propylene-butene (“EPB”) terpolymer, a polypropylene (“PP”) homopolymer, and combinations thereof, with or without the addition of one or more plastomers, elastomers, or ethylene-vinyl-alcohol-based (“EVOH”) and combinations thereof. Examples of suitable elastomers/plastomers include, without limitation, ExxonMobil®'s Vistamaxx®'s (e.g., 6102 and so forth), Dow®'s Versify®'s, and so forth. In yet another example embodiment, the core layer includes a biaxially oriented polyester such as polyester terephthalate (“PET”) or a biaxially oriented polyamide (“PA”).

In additional or alternative example embodiments, the core layer, itself, may be a coated film, and, thereby, produce a multilayer film having more than one coated layer. Take, for example, application of an EVOH coating to a base film. That EVOH-coated surface may have aluminum deposited through vacuum metallization to produce a metallized material, and then the metallized material may be taken through the coater once or more to have one or more sealants and/or other coatings applied to the metal side, opposite to the metal side, or both. This multilayer film would have ultra-high barrier properties and the advantage of sealant technology, all the while avoiding the complexity of coextruding an EVOH layer with polypropylene on an orienter.

The other two of the at least three layers are a primer and a sealing coating, i.e., collectively, the “sealing layer,” which is in direct or indirect contact with a first side of the core layer, which has a first side and a second side. More specifically, the primer is located between the first side of the core layer and a side of the sealing coating, and may offer, for example, wetting and/or adhering enhancement for the film's sealing layer. In alternative, example embodiments, the primer may comprise one or more polymers, such as and without limitation, polyethylenimine-based polymers (“PEI”), polyurethane-based polymers (“PU”), ethylene-acrylic-acid-based polymers (“EAA”), polymers such as elastomers and/or plastomers, and combinations thereof. In various examples, the coating weight of the primer may be within the range of 0.05 to 0.5 g/m². Also in alternative, example embodiments, the sealing coating includes a polyolefin dispersion (“POD”) that is coated onto an outermost surface of the at least three layer film. The POD may contain have a high solids' content, e.g. >25% by weight. The POD may be prepared using BLUEWAVE™ technology and processes developed by Dow®. The POD may include one or more ionomers such as Surlyn®, polymers such as elastomers, plastomers, and combinations thereof, ethylene-vinyl-acetate-based (“EVA”) polymers, vinyl-alcohol-based (“VOH”) polymers, EAA polymers, polypropylene-based polymers, polyethylene-based polymers, organic acids such as maleic-acid-based (“MA”), styrene-block copolymers (“SBC”), amorphous amide polymers and combinations thereof. In alternate embodiments, the sealing layer may be based on acrylic polymers, polyurethane-based polymers (“PU”), polyvinylidene-chloride (“PVDC”) -based polymers, polyethylene terephthalate (“PETG”)-based polymers. The sealing layer may further still include additives, such as those previously listed in this disclosure. In various examples, the coating weight of the sealing coating may be within the range of 0.5 to 20.0 g/m².

In optional, further example embodiments, the disclosed methods, compositions, and apparatuses may include layers in addition to the foregoing at least three coextruded layers. One example of such may include two layers, namely an optional primer and a printable coating, and, collectively referred to herein as a “printable layer.” More specifically, this optional primer is located between the second side of the core layer and a side of the printable coating. In alternative, example embodiments, the optional primer may comprise one or more polymers, such as and without limitation, polyethylenimine-based polymers (“PEI”), PU-based polymers, EAA polymers, and combinations thereof. In various examples, the coating weight of the optional primer may be within the range of 0.05 to 0.5 g/m². Also in alternative, example embodiments, the printable coating may include one or more polymers, such as and without limitation, styrene-based polymers, acrylic-based polymers, styrene-acrylic-based polymers (“SAC”), PVDC such as Daran® 8300, and combinations thereof; further, such one or more polymers may be matte or glossy. In various examples, the coating weight of the printable coating may be within the range of 0.5 to 15.0 g/m².

In optional and still further example embodiments, the disclosed methods, compositions, and apparatuses may include other layers instead of or in addition to the foregoing layers. Examples include one or more metal layers and/or tie layers. The metal layer(s) are positioned intermediate to the core layer. The metal layer(s) may be metallized by deposition of a metal selected from a group including, for example, aluminum, silver, gold, and combinations thereof. The film's layer(s) being metallized may optionally undergo surface treatment, e.g., flame, corona, treatment and combinations thereof, prior to metallization.

In optional and still further example embodiments, the disclosed methods, compositions, and apparatuses may include other oxide (e.g., aluminum, silicon, etc.) layer(s) instead of or in addition to the foregoing layers. Examples include one or more oxide layers and/or tie layers. The oxide layer(s) are positioned intermediate to the core layer. The oxide layer(s) may be vacuum-coated depositions of oxide(s) from a group including, for example, aluminum, silicon, other metals, non-metals, or metalloids, and combinations thereof. In alternate embodiments, the oxide layer may be coated with coating processes, such as direct or reverse gravure, flexography or offset. The film's layer(s) being coated with oxide(s) may optionally undergo surface treatment, e.g., flame, corona, plasma, etc. and combinations thereof, prior to any said vacuum-coated depositions.

The tie layer(s) are positioned intermediate to the core layer and any other film layer, such as, for example, the printable layer, the sealant layer, metal layer(s), and/or therebetween any of the foregoing. Each tie layer of the multilayer film is commonly used to connect two layers, such as two layers that might otherwise not bond well due to incompatibility issues. The tie layer(s) may also provide some other functionality, such as barrier, sealability, and/or machinability enhancement, anti-block particle support, or other benefits, as desired. The tie layer(s) may optionally include one or more plastomers, elastomers, and combinations thereof, regardless whether or not the core layer includes one or more plastomers, elastomers, and combinations thereof.

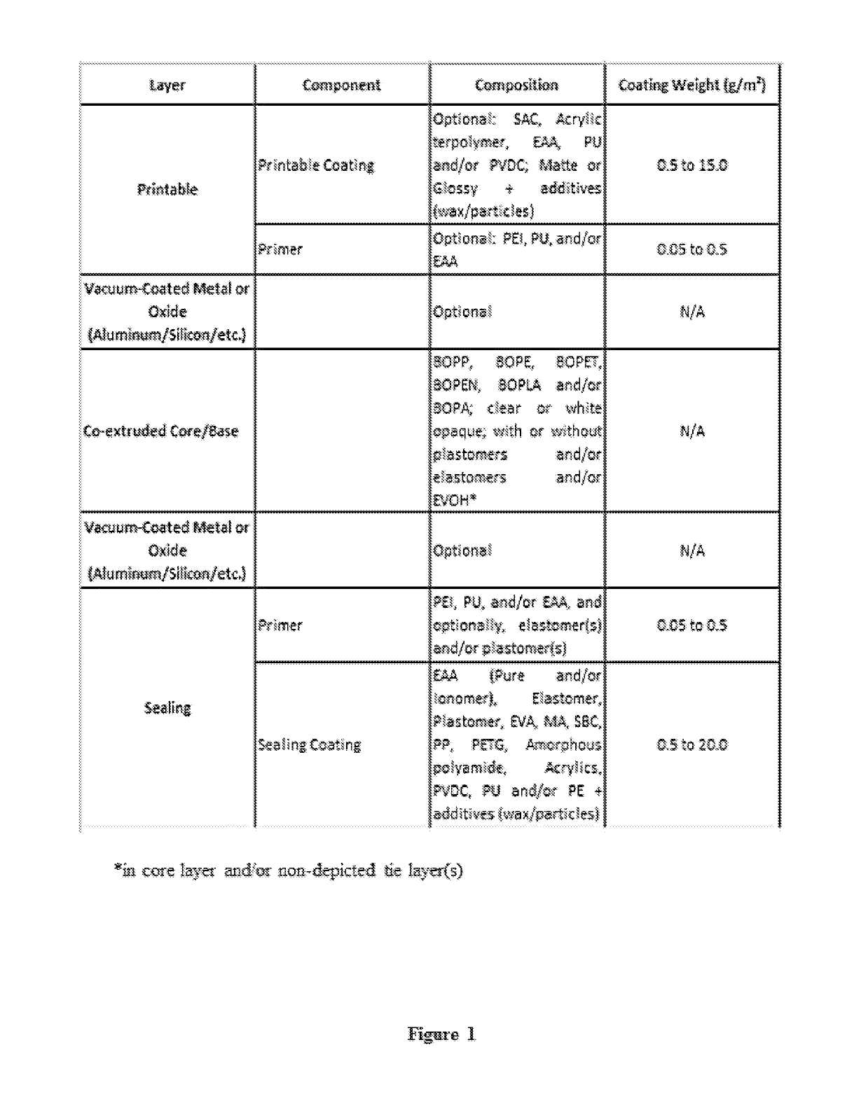

FIG. 1 depicts a tabular representation of example embodiments of the disclosed methods, systems and apparatuses of the at least three layers of the multilayer film.

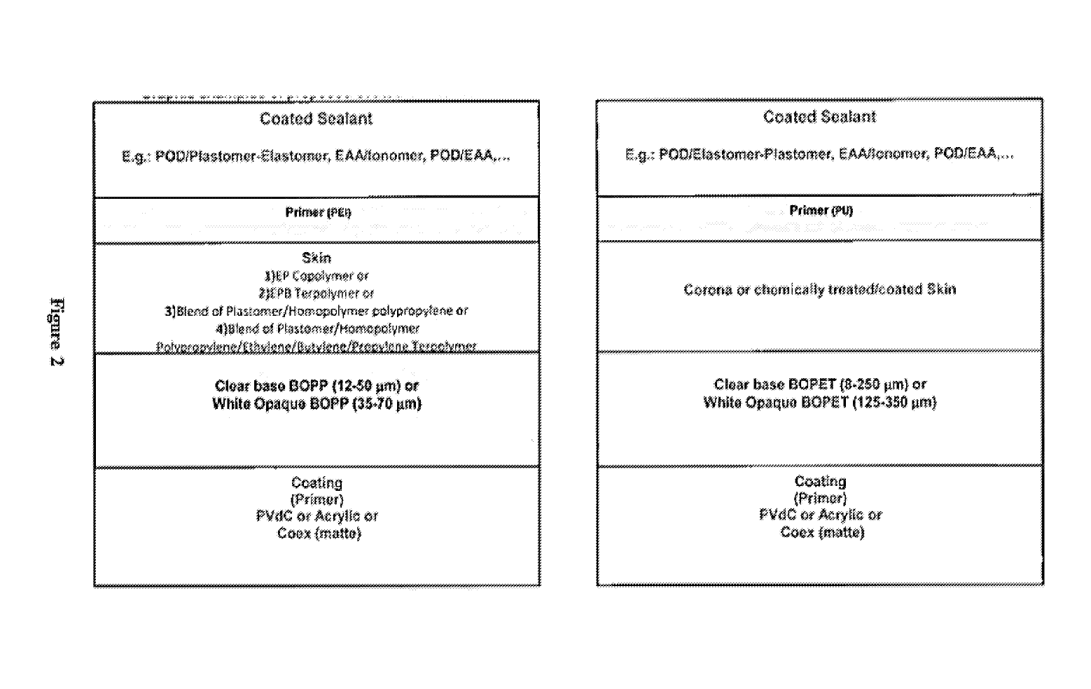

FIG. 2 depicts a tabular representation of example embodiments of the disclosed methods, systems and apparatuses for the sealing layer of the multilayer film.

The treated surface of the metallizable layer of a multilayer film may be metallized via the application of a thin layer of metal. The treated surface may be metallized by vacuum deposition, or any other metallization techniques, such as electroplating or sputtering. In one embodiment, the metal is aluminum, or any other metal capable of being vacuum-deposited, electroplated, or sputtered, such as, for example, gold, zinc, copper, or silver. Although not required, a metal layer is applied to have an optical density (OD) of from 1.5 to 5.0 in accordance with the standard procedures.

The treated surface of the oxide layer of a multilayer film may be vacuum-coated via application of one or more thin layers of one or more oxide(s) or combinations thereof. The treated surface may be coated by vacuum deposition, or any other metallization techniques, such as electroplating or sputtering. In one embodiment, the oxide is based on aluminum, or any other element capable of being vacuum-deposited, electroplated, or sputtered, such as, for example, silicon.

In various embodiments, the disclosed methods, systems, and apparatuses provide for a coated, flexible BOPP, BOPET or BOPA film having at least three layers that include a core layer of PP, PET or PA. Further included are a sealing layer having at least one primer layer of a water-based ethylene-imide, urethane polymer or EAA polymer, of which any of the foregoing also optionally include elastomer(s) and/or plastomer(s), and at least one sealing layer comprising an ionomer (e.g., potassium, sodium, or zinc), elastomer, plastomer, EVA, MAPP, and or blends thereof. Further still optionally included may be at least one metal layer under or opposite the sealing layer. Yet further, optionally included may be at least one printable water-based coating adhered to the opposite of the sealing layer, optionally sandwiching the metal layer between the core layer and printable coating, wherein the printable coating comprises at least one primer layer of a water-based ethylene-imide, EAA, or urethane polymer, and at least one print layer comprising an acrylic-based terpolymer, PVDC, SAC, or blends thereof.

The coating weight of ethylene-imide urethane polymer primer, or EAA polymer may be within a range of from 0.050 g/m² or 0.10 g/m² to 0.20 g/m² or 0.50 g/m².

The optional metal layer(s) are oxidation-treated on either or both sides of the sealing coating, the printable coating, or both coatings.

The printable coating layer may comprise a composition within a range from 70 wt % or 75 wt % to 95 wt % or 100 wt % of a water-based acrylic terpolymer, such as one made of MA-MAA-MMA, where each MA is methyl acrylate, MAA is methacrylic acid, and MMA is methyl methacrylate. In other example embodiments, the printable coating layer comprises within a range from 70 wt % or 75 wt % to 95 wt % or 100 wt % of a water-based PVDC. The printable coating layer may also comprises within the range from 1 wt % or 4 wt % to 8 wt % or 10 wt % of wax, which can be carnauba, montan, bee emulsion, microcrystalline, PE, Fisher-Tropsch, amide or mixtures thereof, and from 0.01 or 0.05 or 0.10 to 0.20 or 0.30 or 0.50 wt % of solid particles having an average particle size of from 0.10 μm to 20 μm or 50 μm; wherein the remainder is a water-based acrylic terpolymer made of MA-MAA-MMA or PVDC polymer in a combined amount up to 95 wt % and no less than 70 wt %. The level of wax and solid particles may be adjusted so that the kinetic and static coefficients of friction (“COFs”) on metal are less than 0.80 or 0.60 or 0.50 or 0.40 or 0.30.

The disclosed films may have a very low temperature sealing coating on the sealing layer.

A food bag or other type of packaging may be formed from the disclosed film, and furthermore, an optionally included metal-side of the film may face or face-away from the food contained therein.

A method for forming the disclosed film may include coextruding at least the core layer, and optionally metallizing at least one side of the core layer, wherein at least one of the metal layer(s) is under or opposite the sealing layer to form a flexible film. The method may include treating the metal layer through oxidative treatment. Further, the method may include directly or indirectly applying a primer to at least one side of the core layer, wherein the directly indirectly depends on whether a metal and/or tie layer is also present. Further still, the method may include applying a sealing coating onto a primer applied to the coating layer. Another primer may be applied to the other side of the core layer or on top of the metal and/or tie layer(s). Yet further, the method may include applying a printable coating layer onto the latter primer discussed in this paragraph in order to form the coated flexible film.

The method may include applying, whether simultaneously, prior, or subsequently to application of the primer and printing coatings, a coating layer of a very low temperature sealing coating for the sealing layer of the flexible film.

The method may also include drying or not drying the primer prior to applying the printable coating. The printable layer may be dried prior to winding and/or slitting the disclosed film.

The method may include unwinding the disclosed film in a VFFS or HFFS or pouches machine and fed therethrough in order to form bags, which may or may ultimately contain food, wherein an optional metal or oxide-side of the disclosed film faces or faces away from the food contained or to-be-contained therein.

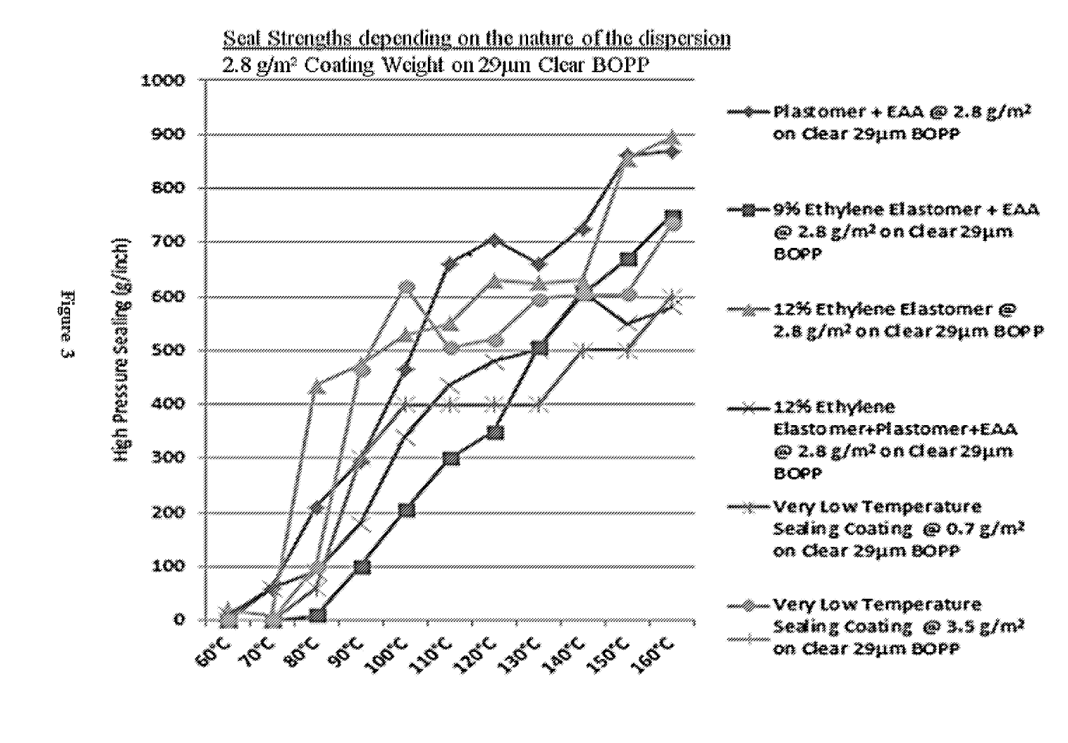

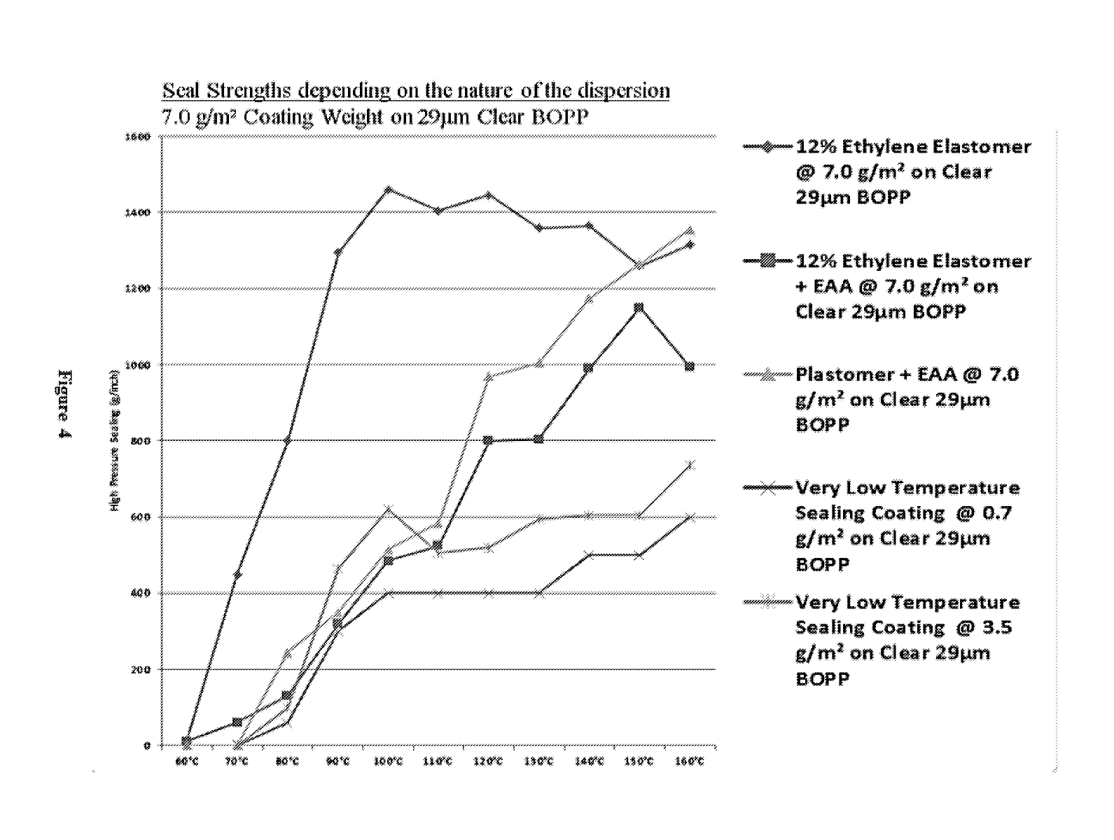

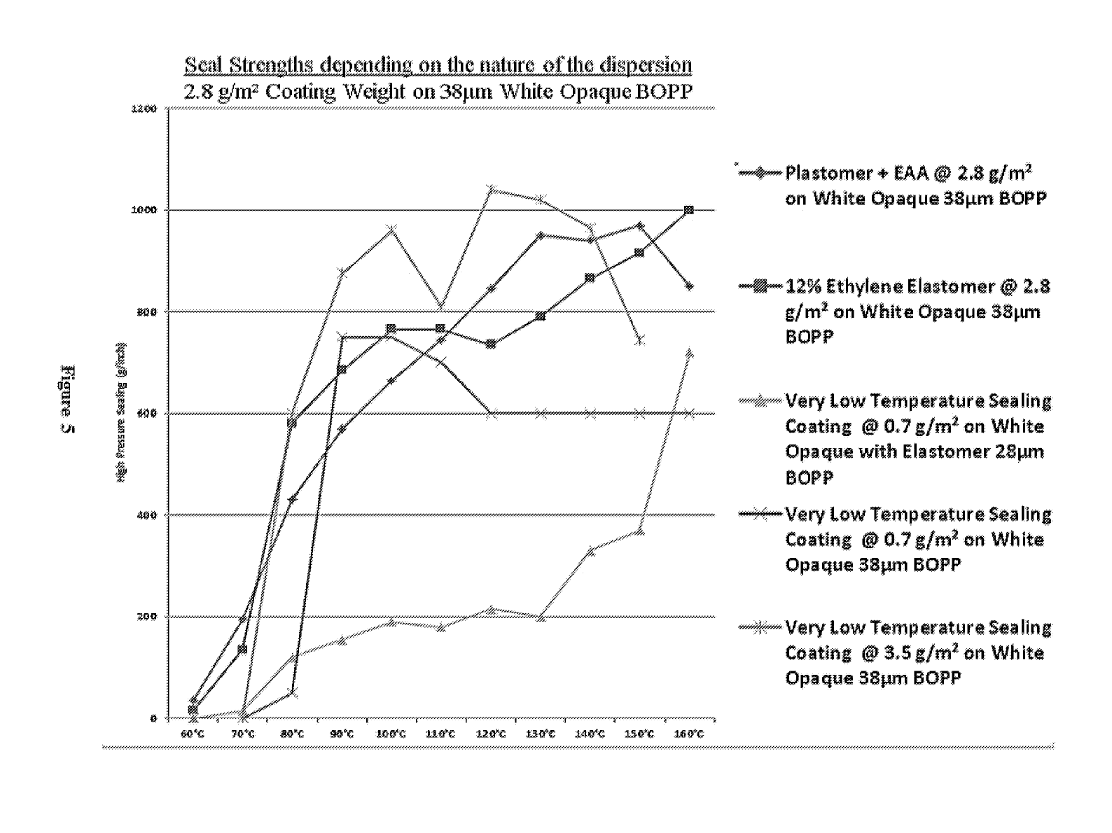

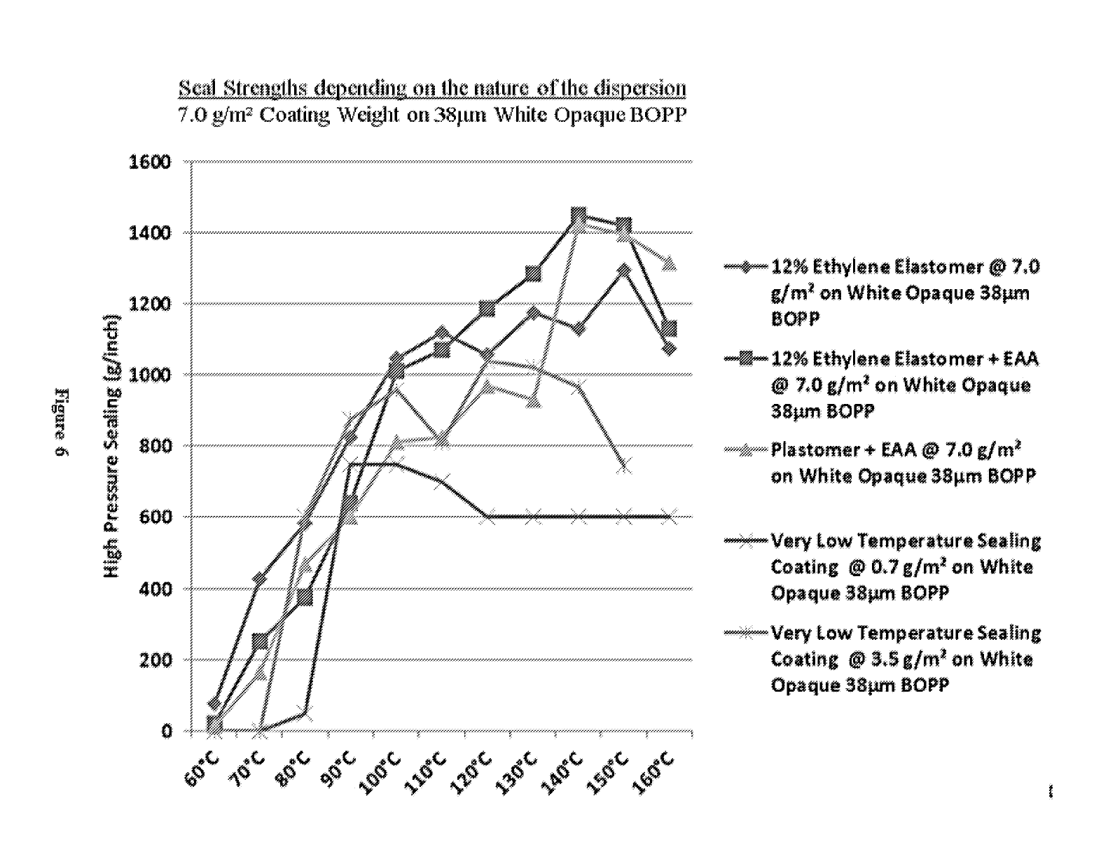

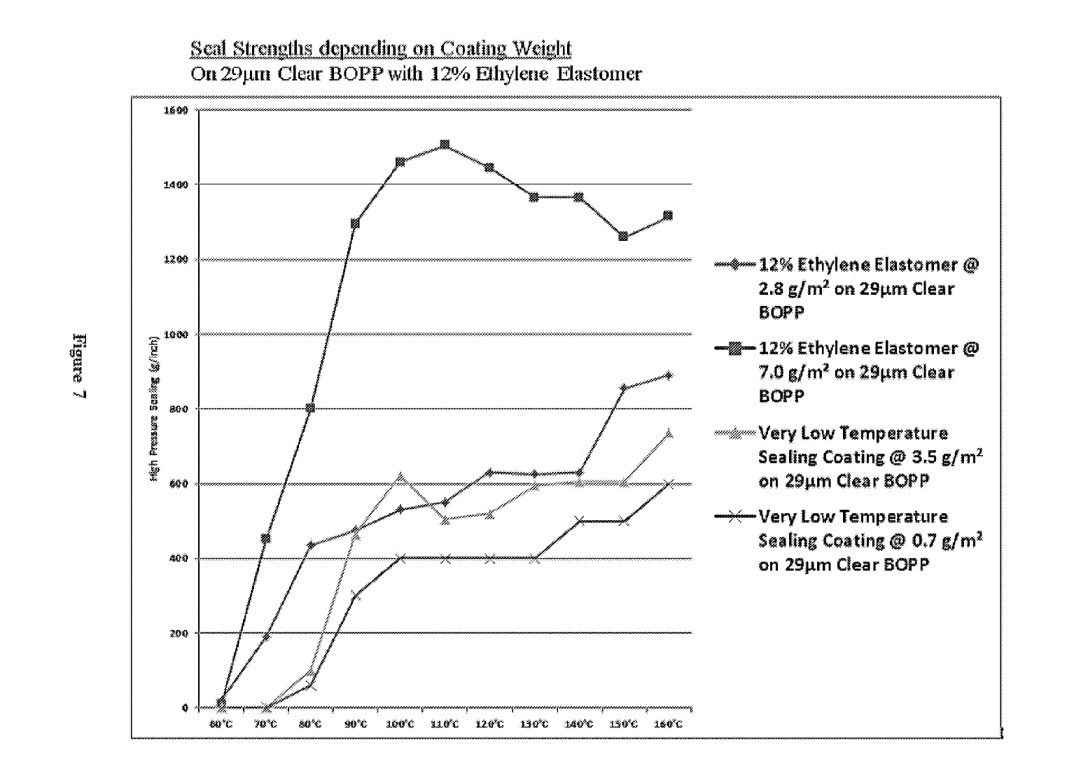

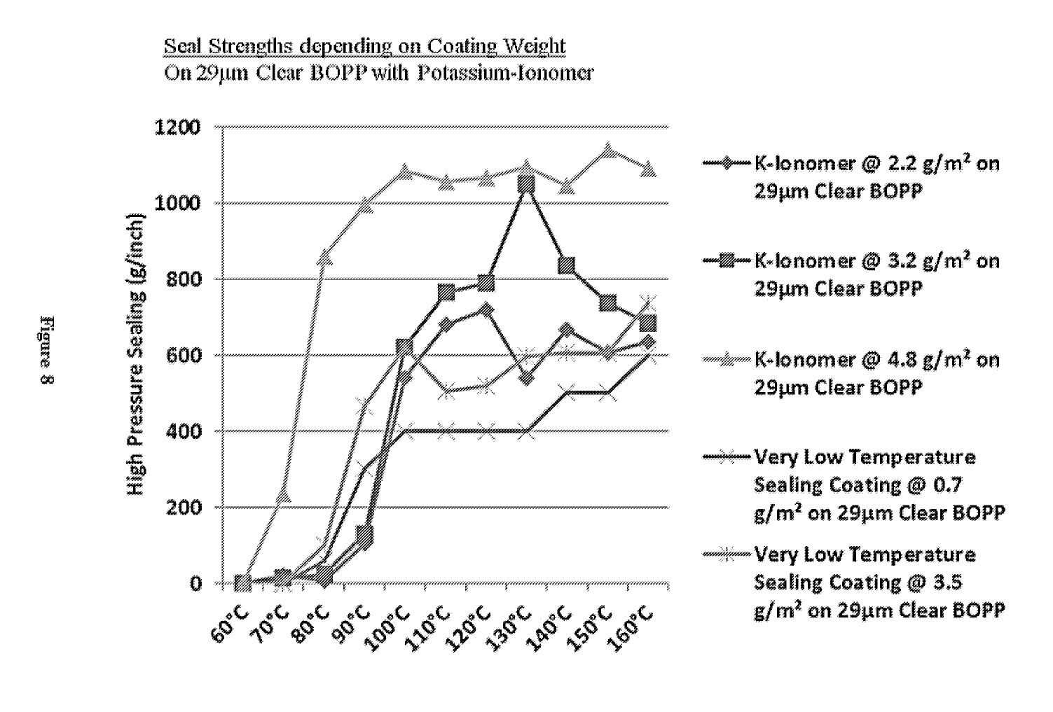

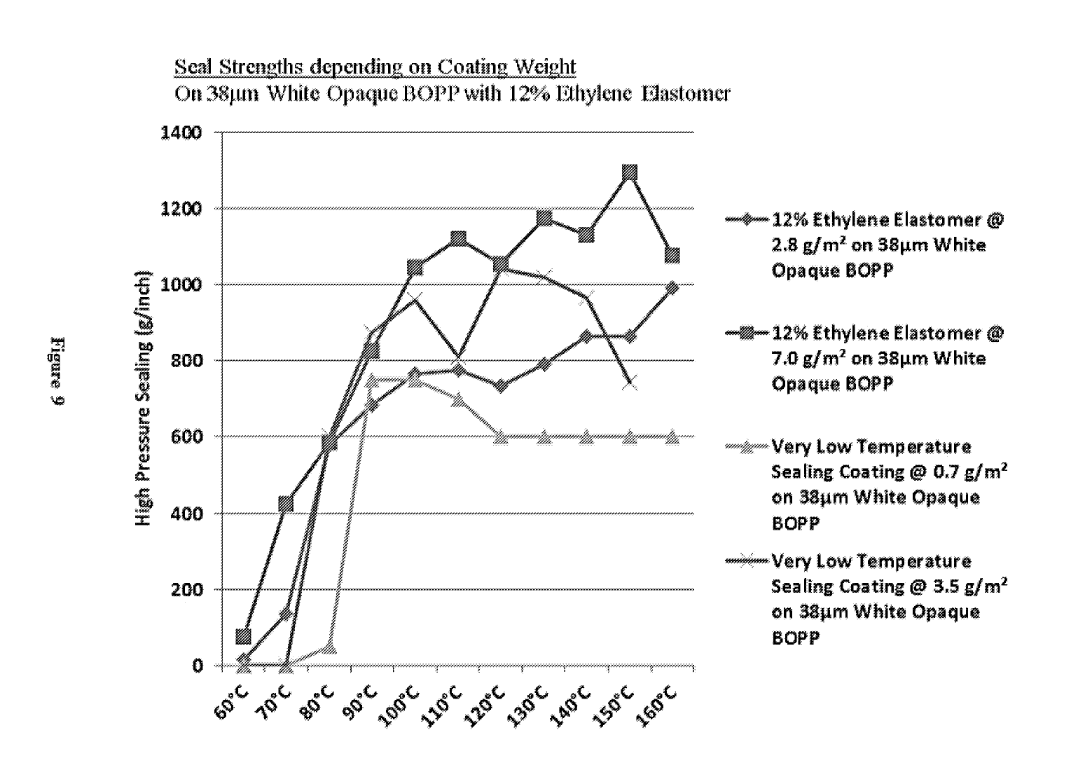

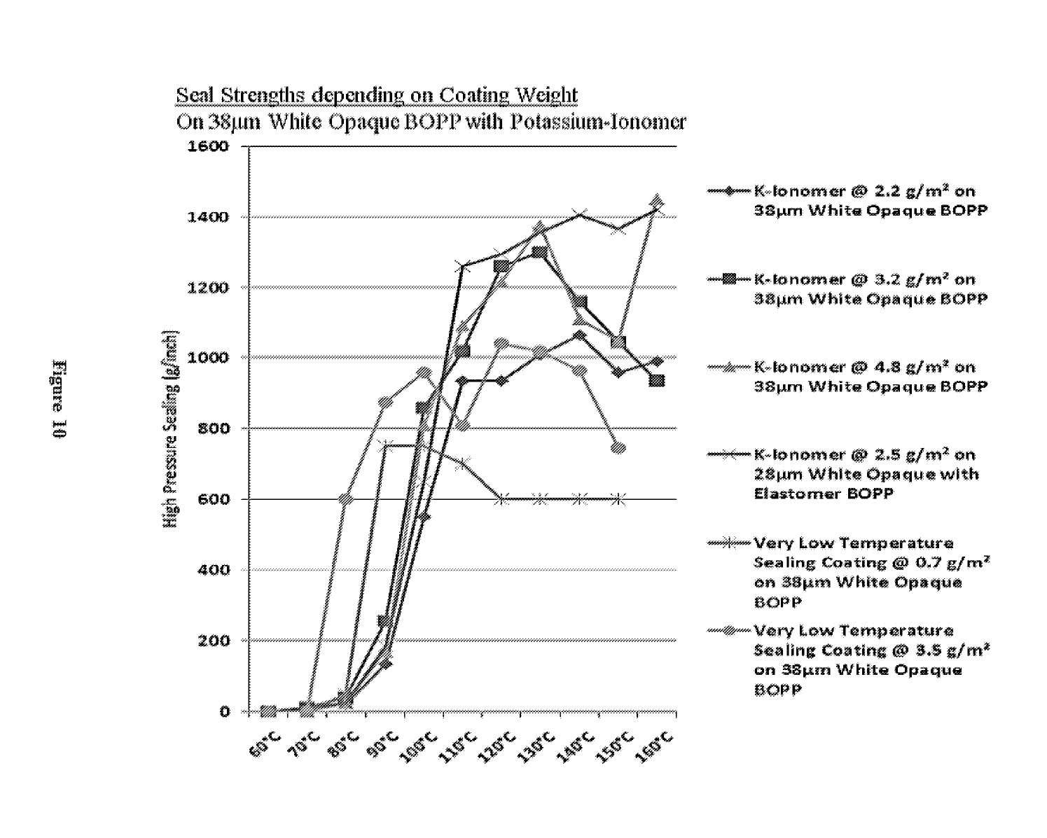

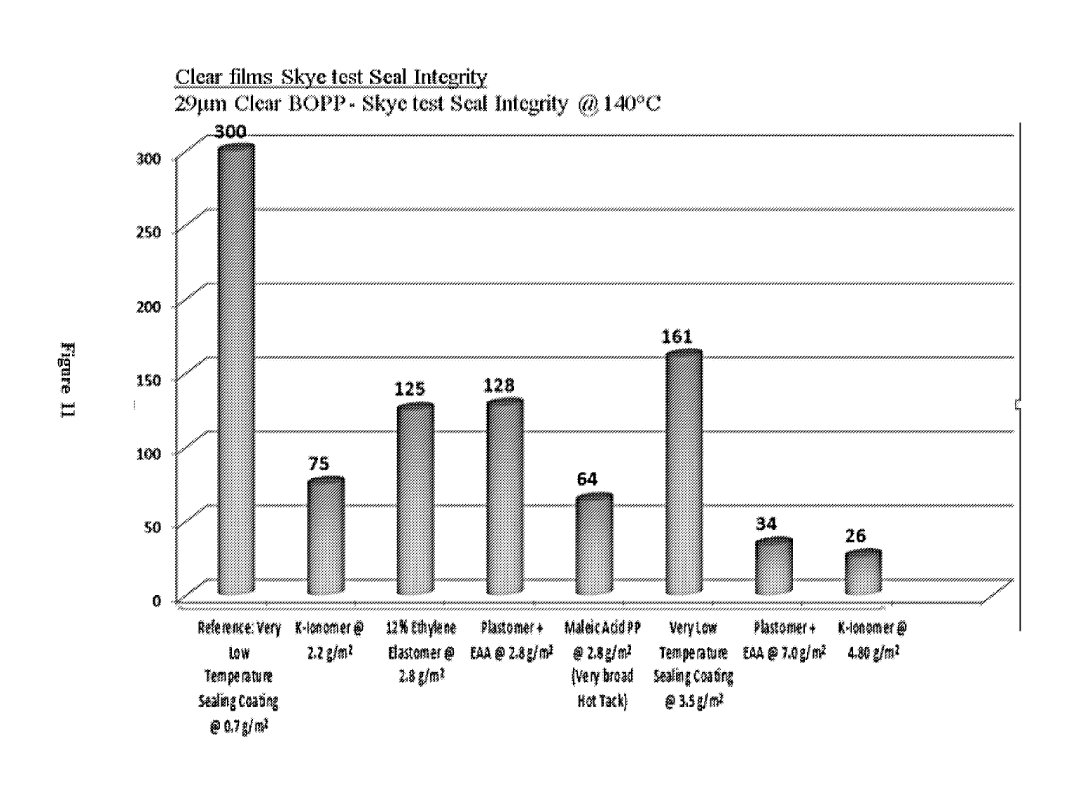

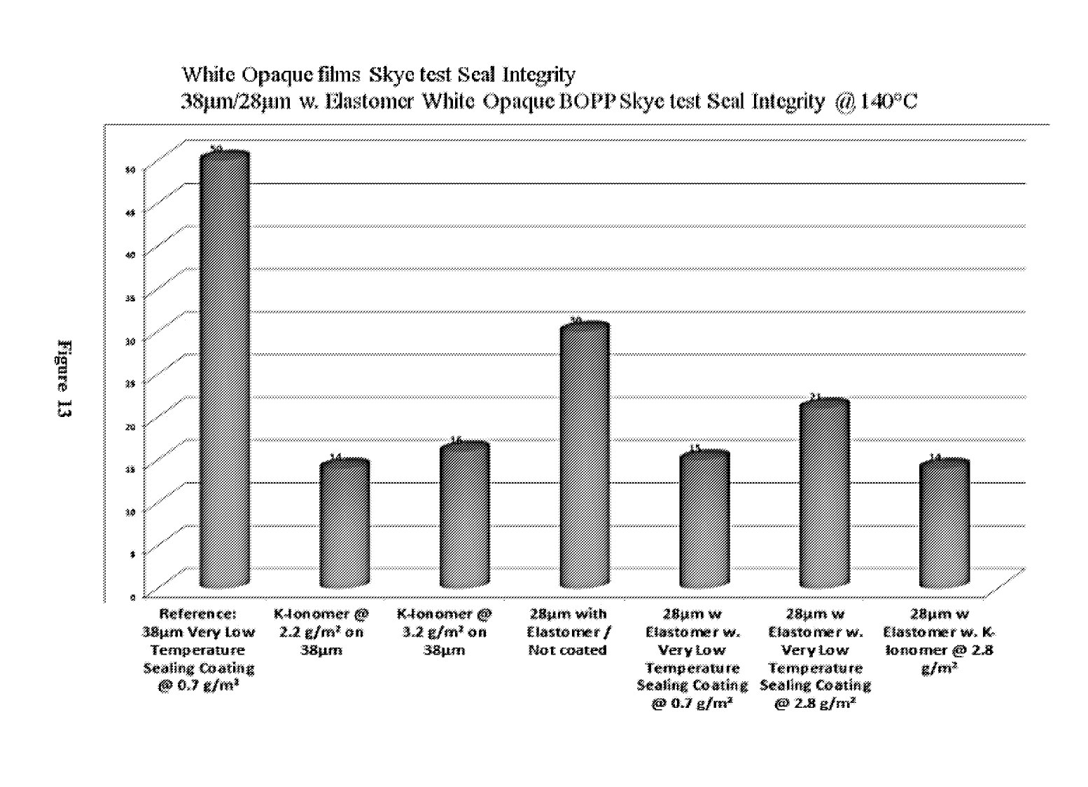

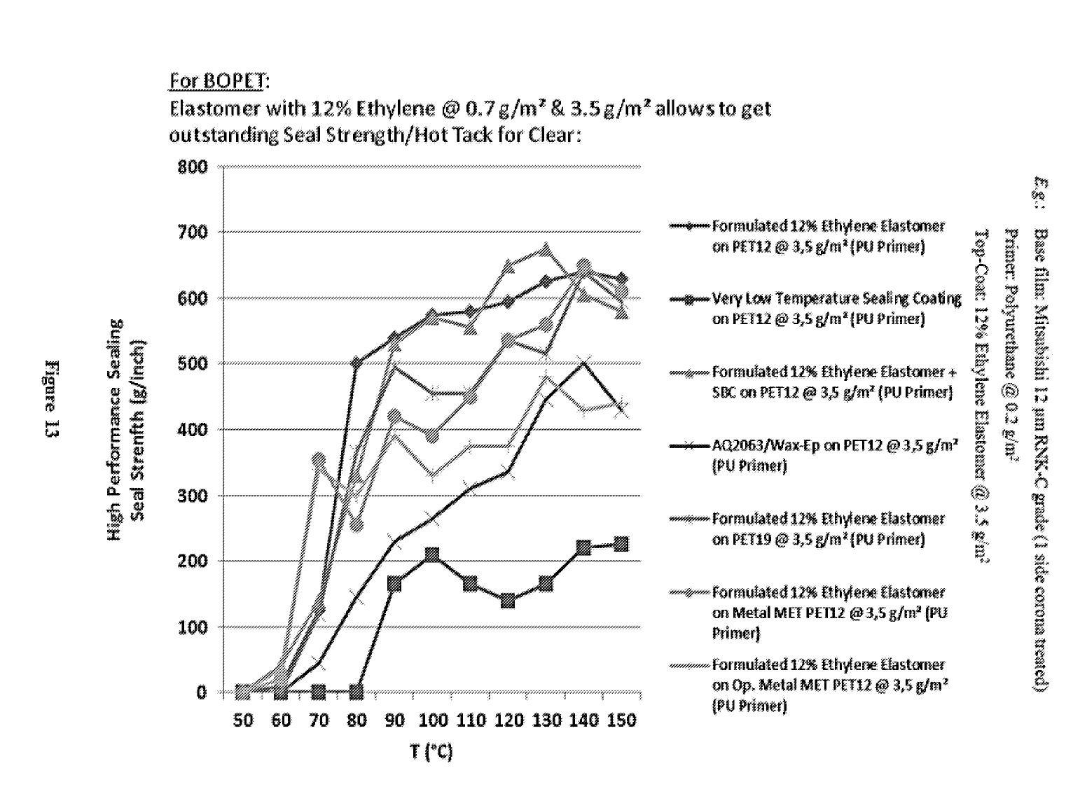

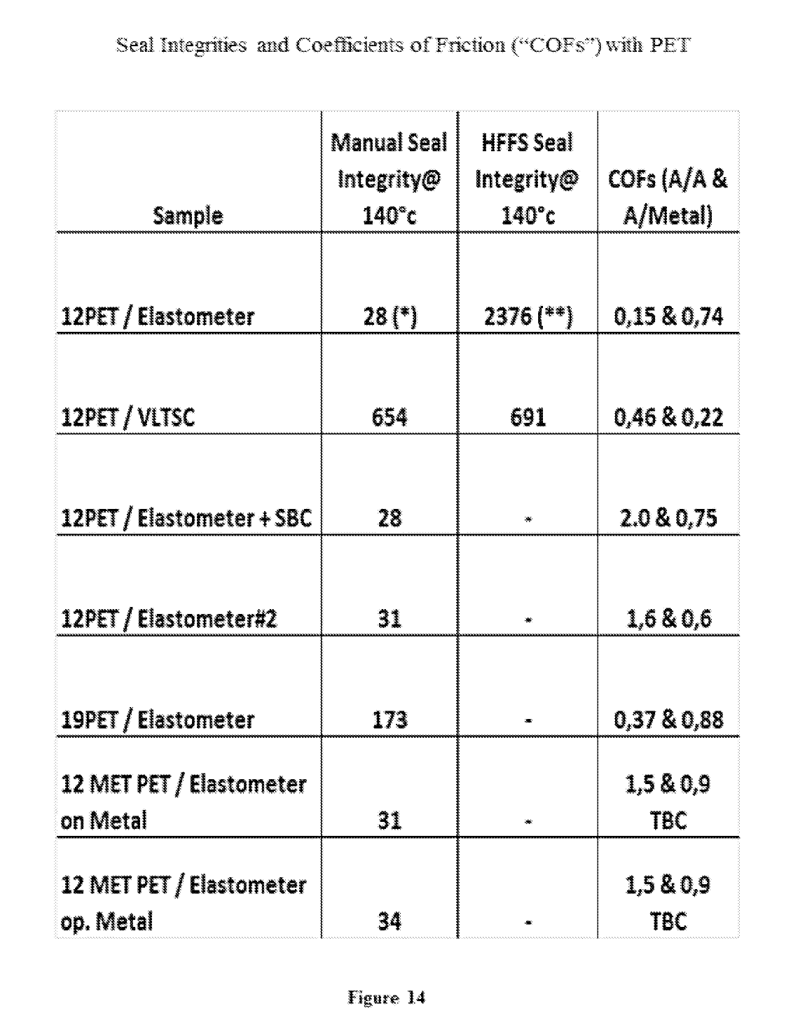

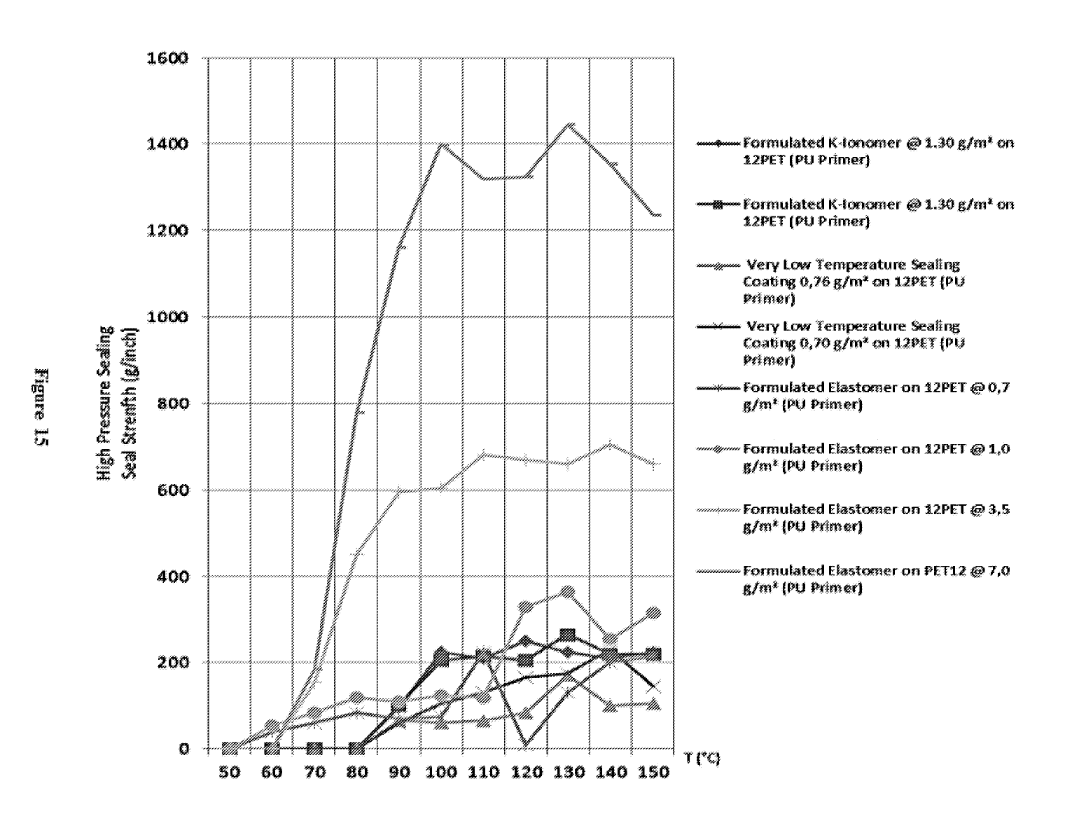

FIGS. 3-15 show experimental results obtained in relation to the disclosed methods, apparatuses and compositions of films herein (i.e., “disclosed films”). A BOPP core layer with an elastomer having 12% ethylene at 7.0 gm⁻² provided outstanding seal strength/hot tack for both clear and white versions. 450 gin⁻¹ at 60° C. provided a very broad hot tack range. The sealing performances through use of an elastomer having 12% ethylene are higher as compared to use of an elastomer having 9% ethylene.

A BOPP core layer with a potassium-ionomer at 2.2 gm⁻² for either clear or white demonstrated the following: an outstanding range of hot-tack with 60 gin⁻¹ spring; a coefficient of friction on metal of 0.4 for clear and 0.5 for white; very low values of blocking on acrylics, PVDC and nitro-cellulose inks at less than 10 gin⁻¹; and outstanding seal integrity with Skye test, i.e., clear was 75 and white opaque was 15.

A BOPP core layer with a potassium-ionomer at 4.8 gm⁻² for either clear or white demonstrated outstanding seal strength performances at 70° C. for clear.

A specific coating from Dow® BLUEWAVE™ technology demonstrated a lower minimum seal temperature (“MST”) versus a very low temperature seal coating. For example, the seal strength was between 200 and 300 gin⁻¹ at 70° C. depending on the coating weight.

Base films containing plastomer and coated either with 2.5 gm⁻² of either potassium ionomer or a plastomer Versify® having 12% Ethylene showed drastic improvement especially with MST. For instance, MST was 75° C. for 300 gin⁻¹ for the coated film having plastomer as compared to an uncoated film with plastomer 100° C. The synergistic effects of the core layer and the sealing layer on sealing performance is thereby demonstrated, i.e., lower coating weight for the same level of sealing versus base films containing no elastomer(s).

In all the cases, the seal strength is impressively large (e.g., >1 kgin⁻¹) for temperatures greater than or equal to 120° C.

Maleic-acid-functionalized PP does not perform well in high-pressure sealing but this film composition does have outstanding hot-tack and seal integrity.

In view of the foregoing, various bags and films may be formed from the above-described, coated, flexible films. For example, in one embodiment, a food bag is formed from a coated flexible film, wherein an optional metal or oxide-side of the film faces away from the food contained therein. In another embodiment, a food bag is formed from a coated flexible film, wherein an optional metal or oxide-side of the film is in contact with (i.e., faces towards) the food contained therein. And, in yet another embodiment, food packaging is formed that may include a sealed bag/pouch made through use of machine-packaging equipment, such as HFFS, VFFS, and/or other pouch packaging machines.

While the foregoing is directed to example embodiments of the disclosed invention, other and further embodiments may be devised without departing from the basic scope thereof, wherein the scope of the disclosed apparatuses, systems and methods are determined by one or more claims.

What is claimed is:

1. A multilayered film, comprising:
a core layer comprising one or more polymers, wherein the core has a first side and a second side and is optionally oriented; and
a sealing layer comprising a primer and a sealing coating, wherein the primer has a primer coating weight from 0.05 to 0.5 g/m² and is located between the first side of the core and a first side of the sealing coating, wherein the sealing coating has a sealing coating weight from 0.5 to 20.0 g/m²,
wherein the multilayered film has a seal strength of at least 1 kg/in at 120° C.

2. The multilayered film of claim 1, further comprising a printable layer comprises a printable coating, wherein the printable layer has a printable layer coating weight from 0.5 to 15.0 g/m² and is located on a side opposite of the sealing layer.

3. The multilayered film of claim 2, wherein the printable layer further comprises one or more printable layer primers having a printable layer primer coating weight from 0.05 to 0.5 g/m².

4. The multilayered film of claim 2, wherein the printable coating comprises from 70 to 100 wt % of a water-based acrylic terpolymer, water-based polyvinylidene chloride polymer, or combination thereof.

5. The multilayered film of claim 2, wherein the printable coating comprises from 1 to 10 wt % of wax, from 0.01 to 0.50 wt % of solid particles having an average particle size of from

0. 10 μm to 50 μm, or combinations thereof.

6. The multilayered film of claim 2, wherein the printable coating comprises a coefficient of friction of less than 0.80.

7. The multilayered film of claim 1, further comprising one or more metal layers, oxide layers, tie layers, or combinations thereof located intermediate to the core and on either or both sides of the core, wherein, optionally, the one or more metal layers and oxide layers are laid down on surface-treated surfaces of the multilayered film.

8. The multi-layered film of claim 1, wherein the core layer further comprises a coating.

9. The multilayered film of claim 1, wherein the one or more polymers in the core layer comprise polypropylene-based polymers or co-polymers thereof, polyester-based polymers, polyethylene-based polymers or co-polymers thereof, polyamide-based polymers, and combinations thereof.

10. The multilayered film of claim 1, wherein the primer comprises polyethylenimine-based polymers, polyurethane-based polymers, ethylene-acrylic-acid-based polymers, and combinations thereof.

11. The multilayered film of claim 1, wherein the sealing coating comprises a polyolefin dispersion having a content of solids greater than 25 wt %, acrylic polymers, polyurethane-based polymers, polyvinylidene-chloride-based polymers, or polyethylene terephthalate-based polymers.

12. The multi-layered film of claim 11, wherein the polyolefin dispersion comprises one or more ionomers, elastomers, plastomers, ethylene-vinyl-acetate-based polymers, vinyl-alcohol-based polymers, ethylene-acrylic-acid-based polymers, polypropylene-based polymers, polyethylene-based polymers, maleic-acid-based or one organic-acid-based polymers, styrene-block copolymers, amorphous amide polymers, and combinations thereof.

13. The multilayered film of claim 1, wherein the core layer further comprises one or more ethylene-vinyl-alcohol-based polymers.

14. The multilayered film of claim 1, wherein the core layer is clear or opaque in color.

15. The multilayered film of claim 1, further comprising additives in any one or more layers of the multi-layered film.

16. The multilayered film of claim 1, wherein the core layer further comprises an ethylene-based elastomer, wherein improved sealing performance is achieved based on the ethylene-based elastomer having a higher percentage of ethylene as compared to a lower percentage of ethylene.

17. The multilayered film of claim 1, wherein the core layer further comprises a plastomer, and wherein improved minimum seal temperature is achieved when the core layer further comprises a coating as compared to no coating.

18. The multilayered film of claim 1, wherein the core layer comprises a polypropylene-based polymer and the sealing coating comprises a potassium-ionomer with the sealing coating weight of 2.2 gm⁻² has a hot-tack with 60 gin⁻¹ spring, a coefficient of friction on metal of approximately 0.4 for a clear multilayered film and approximately 0.5 for a white opaque multilayered film, low blocking on acrylics, polyvinylidene chlorides and nitro-cellulose inks at less than 10 gin⁻¹, and seal integrity under Skye tests of approximately 75 for the clear multilayered film and 14 for the white opaque multilayered film.

19. A method of forming a multilayered film, comprising:
co-extruding a core layer comprising one or more polymers, wherein the core has a first side and a second side and is optionally oriented; and a sealing layer comprising a primer and a sealing coating, wherein the primer has a primer coating weight from 0.05 to 0.5 g/m² and is located between the first side of the core and a first side of the sealing coating, wherein the sealing coating has a sealing coating weight from 0.5 to 20.0 g/m², wherein the multilayered film has a seal strength of at least 1 kg/in at 120° C.

20. A method comprising:
receiving a roll of the multilayer film of claim 1; and forming a package, tag, bag, or label from the multilayered film.
